(19) United States
(12) Patent Application Publication
(10) Pub. No.: US 2011/0167342 A1
(43) Pub. Date: Jul. 7, 2011

(54) CHILD-SAFE MEDIA INTERACTION

(76) Inventors: Isaac de la Pena, Herndon, VA (US); Geraldine Tortelier, Herndon, VA (US); Beth Marcus, Bedford, MA (US)

(21) Appl. No.: 12/963,105

(22) Filed: Dec. 8, 2010

Related U.S. Application Data
(60) Provisional application No. 61/283,717, filed on Dec. 8, 2009.

(51) Int. Cl. G06F 3/048; G09G 5/00; G06F 3/01; G06F 17/30

(52) U.S. Cl. 715/702; 345/629; 715/764; 707/769; 707/E17.014

(57) ABSTRACT

A safe-media interaction system includes distinct child and parent interfaces through which a child can interact with content and applications that are selected and authorized by a parent through the parent interface. The child interface allows a young child who has not yet acquired any reading skills, verbal skills, or visual organization skills to select a content item or application feature from a selection of such items/features visually presented to the child and interact with the selected item/feature through a general purpose computer interface such as a touch screen or keyboard with labels placed over selected keys. The safe-media interaction system also supports special purpose interfaces such as remote controls, kid-safe toys, and a dance pad to facilitate early childhood use of the system.

### CROSS-REFERENCE TO RELATED APPLICATIONS

This application claims the benefit of U.S. provisional application Ser. No. 61/283,717 filed Dec. 8, 2009 and is hereby incorporated by reference in its entirety.

### BACKGROUND OF THE INVENTION

1. Field of the Invention

The invention herein disclosed generally refers to digital content interaction technology, and specifically to child-friendly multimedia and Internet access.

2. Description of the Related Art

In the present day, digital entertainment and interaction is a part of everyday life in the form of cable and broadcast digital television, Internet, and related gadgets such as multimedia wireless phones, wireless multimedia players, digital cameras, and the like. Moreover, digital content and entertainment is readily accessed by all age groups and cultures, often making such uncontrolled availability a matter of concern for parents, civic leaders, religious leaders, socially conscious individuals, and the like, particularly with regard to young children. Likewise, active parental involvement can ensure a healthy and safe digital entertainment experience for children.

In light of the above, a complete solution in the domain of safe digital entertainment for the entire family and in particular young children may prove beneficial to a wide variety of users.

### SUMMARY

Various embodiments of the present invention provide methods and systems for providing safe digital entertainment for the entire family, particularly for young family members.

Embodiments of the present invention may include an apparatus that supports safe digital content and wholly web-based interaction through a variety of special-purpose child-friendly devices. Alternatively, the safe content access capabilities, and the like may be embedded into another manufacturer's device (e.g., a smart phone or an digital game/console). In an embodiment of the present invention, the device may allow players to interact with the apparatus. Further, the device may be connected to the Internet or to any other beneficial peripheral devices. The device may or may not have its own screen, and may depend on an external touchscreen monitor, a standard television, a display screen, or a “tactile sheet” that may be overlaid on a television.

The apparatus may contain a library of media items that may be managed remotely, such as by parents to facilitate safe controlled access by a user, such as a child. These media items may be presented on a screen in a way that may correspond to the developmental stage of the user and may facilitate the interaction by means of an easy-to-understand paradigm. In an example such a paradigm may include spatial relations simulated as a room with frames that may represent digital media items hanging from the walls and doors that may represent digital content storage (e.g. files, folders, URLs, applications, and the like) that may take allow the user to enter other rooms.

The user may use different means to interact with the apparatus, including but not limited to: a conventional or special purpose keyboard, a conventional or special purpose computer mouse, a touch screen, a tactile sheet overlaid on a conventional screen, voice, gestures, a device with contextually shaped buttons or switches, a device that looks much like other standalone toys, an apparatus in which the user may be disposed (e.g. a play seat for a young child that is encircled with various interactive toys and games), a dance pad, an apparatus that may be attached to a playpen, crib, bed, child seat (e.g. attached to a child car safety seat), and the like.

The apparatus may support a wide range of media items, including but not limited to: recorded video, audio, still images, slideshows (e.g. consisting of groups of images and videos with background audio), software applications, games, Internet streaming media, Internet sites such as those that are accessible through a conventional browser, live video with individuals, such as to converse with; i.e. videoconferencing, and the like. Nothing in the description herein is meant to be limiting with regard to the range of media items to be supportable by the invention described herein.

The apparatus may also operate like a conventional television with channels (e.g. offered as a new media item, and/or streaming through the Internet). A difference from conventional television that may be provided by the invention may be in being able to augment the television display with other information that may be accessible through the invention. Examples of such information may include but is not limited to information that the children may interact with, suggestions (time for home work, time for snack, time to play with your sibling), merchandising, subtitles, and a wide variety of other information.

In addition, a timer functionality that may be used to provide the additional information and/or shutdown the application, media item, any portion of the device or the like that triggers based on a programmable schedule may be included. The user may receive soft, friendly reminders that a session is about to finish soon before shutting down.

In addition, parents or other authorized users may control usage of the apparatus (and reinforce good habits relating to use of digital content and media with users, such as with children) by means of a rewards mechanism that may require the use of a certain number of digital “coins” per unit of time to operate the apparatus. Reward coins may be awarded on a periodic basis (e.g. weekly basis) or upon completion of certain tasks (e.g. cleaning up the dishes, having great scores in the last school paper, etc).

The look and feel of any portion of the media library and other components associated with the apparatus may be customized on the fly, such as by acquiring new “skins” in order to fit branding requirements of corporate partners, aesthetic preferences of consumers, and the like.

In embodiments, users and in particular children may acquire and play digital books and songs (with or without visuals) that may be customized by a child's parents (e.g with their own voices) so that the child can play and hear the parent's voice in the context of the book or song any time. Alternatively, a parent could record an original media item that the child may access through the interface.

The apparatus may include a variety of accessories which are relevant for the application of digital content access technology and also may increase the perceived value, enjoyment of use, and/or utility of the invention. These may include a child accessible digital camera that a child may operate to shoot videos and pictures that may be seamlessly downloaded and integrated with the medial library to be shared with family, relatives, friends, and the like. A microphone for recording a user singing along during playback of movies, television, songs, and the like may also be included.

In embodiments, the merchandising option may facilitate a user selecting merchandise to be put on a “wish list” either by touching on specific items displayed in the screen or pressing a key on a user interface that is associated with the item being displayed. These interactions may be communicated to the parents or caregivers who could get notified this “wish list.”

The apparatus may silently log all the interactions of the user with the platform, so as to provide meaningful statistics and allow parents or other authorized individuals to review the logged interactions via a simple web interface. Parents may subscribe as well to a parental advisory service that leverages usage patterns to assess the development of the child and provide recommendations for future activities, new media items, etc.

In an embodiment of the present invention, an apparatus is provided. The apparatus may include a processor, a communication facility, and a gaming console. The communication facility may be configured to connect to Internet. Further, the gaming console may include a plurality of controls that may be laid over a display interface. The plurality of controls may be configured to allow a child to play a game.

In an embodiment, an overlay for a display may include controls that may be configured to allow simplified interaction with a system associated with the display. The system may also be designed for a general user. Further, the controls may be configured to allow simplified interaction based on a target age range of a user. The target age range may be one of 0-1, 1-1.5, 1.5-2.5, 2.5-4, 4-6, and 6-8.

In an embodiment, a processor controlled device is provided. The device may allow simplified interaction with a digital content system that may be designed for use by a general user.

In an aspect of the present invention, systems and methods include selecting a digital image to represent computer renderable content. The digital image may be associated with the computer renderable content for presentation in a child-specific user interface. Further, a keyboard key may be associated with the renderable content. The association may facilitate activating the renderable content with the keyboard key. A label of the digital image may also be selected from a collection of age-specific labels. In an embodiment, the digital image may be at least one of a picture, video, games, movies, online applications, and the like. Further, the child-specific user interface may include visual indicators to facilitate a user to determine the Internet connectivity. The labels may include at least one of a figure, letter of alphabet, words, and the like. In addition, the labels may be self-stick adhesive labels, peel-off labels, and the like.

In an embodiment, a method includes taking a keyboard key identifier that may be associated with computer renderable content. The computer renderable content may be accessible through a child-specific user interface. Further, a label may be selected from a collection of age-specific labels. The age-specific labels may approximate a digital image that may represent the computer renderable content. The selected label may be disposed on a key of a keyboard based on the keyboard key identifier. The disposed label may facilitate activation of the renderable content with the keyboard key. In an embodiment, the digital image may be at least one of a picture, video, games, movies, online applications, and the like. Further, the child-specific user interface may include visual indicators to facilitate a user to determine the Internet connectivity. The labels may include at least one of a figure, letter of alphabet, words, and the like. In addition, the labels may be self-stick adhesive labels, peel-off labels, and the like.

In an aspect of the invention, systems and methods for recommending content and features for a safe-media interaction system are provided. The systems and methods may include collection of interactions of a plurality of child users with a plurality of child-specific user interfaces. The interactions may be collected by using a recommendation engine. Further, the interactions across the plurality of child users and over time may be aggregated. The aggregated interactions may be analyzed to detect patterns and tendencies. The detected patterns and tendencies may be associated with a demographic aspect of at least one child of the plurality child users. Furthermore, at least one of a content item and a feature may be recommended for being included in a child-specific user interface of the at least one child. In an embodiment, the recommendations may include at least one of future activities, new media items, and the like. Further, the recommendation engine may generate reports based on the interactions of users with the safe-media interaction system.

In an aspect of the present invention, systems and methods of facilitating access to blended content in a child-specific user interface is provided. The systems and methods may include taking an identifier of user generated content. The identifier may include information that may facilitate a computer accessing the user generated content. Further, an identifier of at least one of on-line content and audio-book content may be taken. The identifier may include information that may facilitate a computer to access the content. In addition, the systems and methods may include configuring a user interface for the child-specific user interface to blend the user generated content with at least one of the on-line content and the audio-book content. The contents may be blended by associating the identifier of the user generated content and the identifier of the at least one of on-line and audio-book content with the child-specific user interface.

In an embodiment, the child-specific user-interface may be configured through a parent interface. Further, user generated content may include content created by a user such as home generated videos, images captured during a vacation, audio recordings, and the like. In addition, the on-line content may include freely available content. The audio-book content may include freely available digital content.

In embodiments, systems and methods of interfacing with a safe-media interaction system is provided. The systems and methods may include providing a first user interface to the safe-media interaction system. Further, the systems and methods may include providing a second user interface to the safe-media interaction system. The systems and methods may also include configuring one of the first and second user interfaces as a child-specific user interface. The other of the first and second user interfaces may be configured as a parent-specific user interface. The child-specific user interface may be configured by the parent-specific user interface. The configuration of the child-specific user interface through the parent-specific user interface may include editing the content of a child's profile. Editing may include adding selected content, deleting old content, tracking interactions between children and the safe-media interaction system, and the like.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the detailed description of certain embodiments thereof may be understood by reference to the following figures:

FIG. 1 depicts a block diagram of a safe-media interaction system;

FIG. 2 depicts a customized user interface of the safe-media interaction;

FIG. 3 depicts a content selection screen of a child-specific user interface of the safe-media interaction system;

FIG. 4 depicts distinct parent and child interfaces to the safe-media interaction system;

FIG. 5 depicts a recommendation engine and method that is associated with the safe-media interaction system;

FIG. 6 depicts a dance pad input device that is associated with the safe-media interaction system;

FIG. 7 depicts a game or other feature of the safe-media interaction system that facilitates interaction with the dance pad of FIG. 6; and

FIG. 8 depicts accessing multiple types of content through a child-specific user interface of the safe-media interaction system.

### DETAILED DESCRIPTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one as or more than one. The term “another,” as used herein, is defined as at least a second or more. The terms “including” and/or “having” as used herein, are defined as comprising (i.e., open transition). The term “coupled” or “operatively coupled,” as used herein, is defined as connected, although not necessarily directly and not necessarily mechanically.

The disclosed invention and its various embodiments may facilitate interaction of children with the family-owned digital entertainment media that allows access to the television and the Internet, while at the same time enable parents to exert remote control on what the child is accessing through a simple web interface.

Moreover, the various embodiments of the system of the present invention may include technology that has features allowing parents to foster their children's education within the limitations of their busy lives and keeps all family members connected, regardless of age or location. For instance, addition of a camera to the safe digital entertainment device may allow video-conferencing with trusted family members. Parents may also access free on-line content and buy movies, games, etc. in a digital store that offers child-safe media.

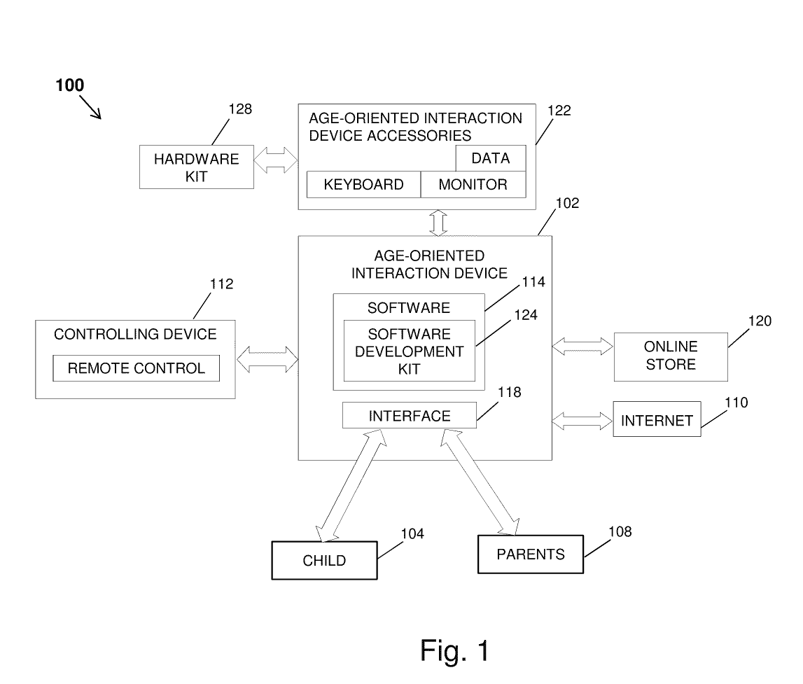

Referring to FIG. 1, the invention may include a safe-media interaction system 100 for providing enhanced audio, video or content and media to users. The safe-media interaction system 100 may be used in combination with traditional media and content devices to enhance the user's experience by provisioning selected additional information. The additional information could be in the form of digital content that is interactive, educational, instructional, commercial, and the like. The safe-media interaction system 100 may be customized to support languages such as English, Spanish, Chinese, and the like.

The safe-media interaction system 100 may include an age-oriented interaction device 102. The age-oriented interaction device 102 may resemble a portable handheld computer that may be capable of running software of a game. The age-oriented interaction device 102 may include a microprocessor for carrying out various instructions of the safe-media interaction software 114. The age-oriented interaction device 102 may be connected to the Internet 110 or any other required peripheral such as a printer, a keyboard, and the like. The age-oriented interaction device 102 may manage interactions between users and the safe-media interaction system 100. Further, the age-oriented interaction device 102 may be integrated with a wired network such as LAN, WAN, and the like.

The age-oriented interaction device 102 may be rugged to protect the device from scratches. Further, the age-oriented interaction device 102 may be shock-resistant thereby ensuring reliable operation with moderate abuse by the users. The age-oriented interaction device 102 may be portable and may be the size of a smart phone or PDA for being carried conveniently by users. The age-oriented interaction device 102, as disclosed herein, may run a simple operating system such as Linux for maintaining speed and efficiency of the safe-media interaction system 100. Further, the age-oriented interaction device 102 may be aesthetically appealing for children. In an example, the age-oriented interaction device 102 may be in form of a toy that children may find attractive. In another example, the hardware and software associated with the age-oriented interaction device 102 may be fitted in a toy for attracting children.

The age-oriented interaction device 102 may include enough memory to store at least a few media items and applications to support offline use (e.g. 8 GB of memory). The memory for storing the media items may preferably be solid-state memory to facilitate shock resistance and may include FLASH memory devices, non-volatile memory cards, CD-ROMS, and the like.

The age-oriented interaction device 102 may include Universal Serial Bus (USB) ports to connect peripherals such as keyboards, printers, and the like (e.g. 4 ports). The age-oriented interaction device 102 may not have a display screen. Alternatively, the age-oriented interaction device 102 may be connected to an external television, computer monitor, or other display device that supports video and/or audio output. Further, the age-oriented interaction device 102 may be connected either through a dedicated port or an accessory adapter that may be included in the commercial bundle. Versions of the age-oriented interaction device 102 may include a display screen. The age-oriented interaction device 102 may include a built-in Wi-Fi interface to connect wirelessly to the Internet 110, peripherals, local networks, a nearby computer, other safe-media interaction systems 100, and the like.

The age-oriented interaction device 102 of the safe-media interaction system 100 may interact with one or more output devices to provide information in the form of audio or video content. The output devices may form a part of the safe-media interaction system 100. In other embodiments, the output devices may be externally interfaced with the safe-media interaction system 100. Examples of such external devices may include, but are not limited to a television, a computer (or other computing devices), a phone (or other telecommunication devices) and portable devices such as mobile phones, Personal Digital Assistants (PDA's), and the like. The safe-media interaction system 100 may interact with these devices over a wired or a wireless communication link. The communication links may include Wi-Fi, USB, and the like. The communication link may be any communication link available in a home environment.

The age-oriented interaction device 102 of the safe-media interaction system 100 may be connected to an external touch screen monitor either through a dedicated port or an adapter that may be included in the commercial bundle. The age-oriented interaction device 102 may be customized with various aesthetics such as a princess special edition and the like for ease in marketing. Further, the safe-media interaction system 100 may include self-stick adhesive labels that may facilitate a child to interact with the safe-media interaction system 100.

The safe-media interaction system 100 may include a remote control device 112 for operating the age-oriented interaction device 102 wirelessly. Specifically, the remote control device 112 may be an independent hardware accessory that is manipulated by the children to control various features of the age-oriented interaction device 102. Preferably, the remote control device 112 may be similar to a remote control of a gaming console. The remote control device 112 may be rugged to protect the device from scratches. Further, the remote control device 112 may be shock-resistant. The remote control device 112 may be portable for facilitating easy transportation by users. In an embodiment, size and appearance of the remote control device 112 may vary depending on the age of the child. In an example, if the remote control device 112 is to be used by a 1 year old, the remote control device 112 may include big, colorful keys made of a plastic material. On the other hand, if a 6 year old child wants to use the remote control device 112, the remote control device 112 may include levers or joysticks. The remote control device 112 may further include limited access buttons for specific applications such as for connecting to Wi-Fi, accessing facebook, and the like. Parents may configure the invention so that children below a predefined age may not be able to operate the limited access buttons. These limited access buttons may be activated for the children as they become familiar with the remote control device 112; the limited access buttons may allow children to access additional content, games, educational material and the like.

The remote control device 112 may include buttons for performing various functions that are also accessible on the age-oriented interaction device 102. A range of controls with different complexity levels may be configurable to depend on the developmental stage of the children. In an example, the remote control device 112 developed specifically for children in the age group of 1 to 1.5 years may include only two buttons. The buttons may be marked as “Next” and “Play.” The remote control device 112 for children in the age range of 1.5 to 2.5 years may include buttons allowing two-directional movement of the displayed data object, such as movement to the right and left directions, or movement in upward and downward directions, and the like. Further, the remote control device 112 may also enable the child to control about 4-6 items on the display screen.

In an embodiment, the remote control device 112 may allow the child in the age group of 2.5-4 years to control about 8-12 items on the display screen. Further, the remote control device 112 may enable the child to have a 4-directional movement of the displayed objects. The remote control device 112 may include special purpose buttons that enable the child to manage a list of contacts, access facebook, and the like. In an exemplary embodiment, the remote control device 112 when manufactured for use by children in the age group of 4-6 years may include levers, joysticks, and the like. The remote control device 112, in such cases, may enable double 4-directional movements of the displayed objects.

The remote control device 112 may include a built in Wi-Fi interface that may facilitate wireless connectivity with the age-oriented interaction device 102 of the safe-media interaction system 100. Wireless connectivity of the remote control device 112 may avoid domestic accidents or physical harm to the children. The safe-media interaction system 100 may include other input paradigms than key presses, such as gestures, touch, voice, and the like, which may be relevant to an age range.

The safe-media interaction system 100 may include safe-media interaction software 114 such as client-side software that may run on the age-oriented interaction device 102. The safe-media interaction software 114 may provide rich media experience to the children. Optionally, the safe-media interaction software 114 may be purchased independently in order to run on other hardware platforms, if required. In an example, the safe-media interaction software 114 may be embedded in a smart phone or other portable devices, a gaming or entertainment device, a computer or other computing devices such as laptop, and the like. The safe-media interaction software 114 may interface with the Internet to identify cost-competitive offering for educational software's and may display the same to the child. In an example, a child may play with a demo version of software ‘LEARN’; the child may get interested in it and subsequently a message may be provided to the parents regarding the child's interest in the given software.

The safe-media interaction software 114 may include access to a media library having a plurality of media items that the children may select from. These media items may be presented on a display screen associated with the invention in a way that corresponds to the developmental stage of the child. Further, the media items may facilitate interaction by means of an easy-to-understand paradigm. In an example such a paradigm may include spatial relations simulated as a room with frames that may represent digital media items hanging from the walls and doors that may represent digital content storage (e.g. files, folders, URLs, applications, and the like) that may allow the user to enter other rooms. In an example, the child may be required to match a particular object with a particular room, failing which the child may not be able to move ahead in the particular application, thus improving the child's imaginative skills

The safe-media interaction software 114 may include an interface 118 that may automatically adapt to the complexity of the remote control device 112 that the child may be using in that moment. In an example, when the child is switched to the 8-button control, automatically 8 items may be displayed simultaneously on the screen. The safe-media interaction software 114 may also seamlessly start applications to match the desired input mode. In an example, if the child grabs a HARRY POTTER magic wand (and the wand has been enabled through the parental control capabilities of the invention), the safe-media interaction software 114 may start a HARRY POTTER game. Further, when the wand is turned off by the child, or set aside for a configurable amount of time, the game may stop.

The safe-media interaction software 114 may play streaming media directly from the Internet 110. Specifically, the safe-media interaction software 114 may play such multimedia files that may be constantly received over the Internet and may be presented to the user. For all the media specifications that may follow, it may be understood that live streaming may be configured as the default way of media consumption. The safe-media interaction software 114 may automatically classify the media files into various categories. Moreover, the safe-media interaction software 114 may identify items as a favorite based on a measure of the usage of media files Likewise, the safe-media interaction software 114 may enable the user to have offline access of saved media files and other items.

The safe-media interaction software 114 may play video files over the Internet 110 in an optimized format, such as Flash Video, MPEG-4 Video, and the like. The safe-media interaction software 114 may play audio files in an optimized format such as MP3, RA, and the like. The safe-media interaction software 114 may play still images in an optimized format such as PNG, JPEG, and the like. Moreover, the safe-media interaction software 114 may also play slideshows including combinations of media files. For instance, the safe-media interaction software 114 may play a series of still pictures in JPEG format from a holiday trip with background music in MP3 format. When referring to the safe-media interaction software 114 playing a media file, we also mean the software 114 activating and/or interacting with other software, such as MP3 player software and/or various codecs and the like to support playing of the media file(s). The safe-media interaction software 114 may provide an association of a media file, in particular a customized media file, with one or more media file playing applications.

The safe-media interaction software 114 being a controlled environment may be configured to limit support for multi-format files. However, support for a wide variety of single and mixed-format media file formats may be provided in some embodiments and not in others depending on the extra storage and processing power requirements for the mixed-format support. The interface 118 may include a plurality of tools for changing the format of files. In another embodiment, the various formats may be provided on an external PC. Enough support may be provided online for the seamless conversion of formats for home-brew media when publishing content.

The safe-media interaction software 114 may execute certified applications in a sandbox that is logically isolated and secured separately from other resources of the safe-media interaction system 100. The safe-media interaction software 114 may display parental-approved web content via a chromeless browser window. The chromeless browser window may not include a conventional interface that may include chrome elements such as a title bar, browser buttons, a status bar, and the like. Absence of such elements may allow parents to implement their own chrome to a child's user interface. For example, parents may decide how the title bar should look, the buttons to display, whether to render a border, and the like. Such web content may include videos such as YouTube, games, and the like. The interaction between the child and the safe-media interaction system 100 may be strictly controlled to provide a safe browsing environment for the child. The safe-media interaction software 114 may include or provide access to scheduling functionality that may trigger certain aspects of the safe-media interaction system 100. In an example, a parent may select or specify particular time duration for an interactive session between a child and the safe-media interaction system 100. Likewise, the scheduling functionality may facilitate providing soft reminders to the child that the session is about to finish. Thereafter, the session may shut down.

The safe-media interaction software 114 may log all the interactions of the child with the safe-media interaction system 100 so as to provide statistics. Parents and/or those authorized to access the logged information may keep a check on the durations of interactions, time of interaction, types of interaction, type of interaction device being used, content being requested, and the like between the child and the safe-media interaction system 100. The safe-media interaction software 114 may be updated automatically, such as from a Server to download and install new versions of the safe-media interaction software 114 upon authorized approval (e.g., parent approval).

The safe-media interaction system 100 may include some applications such as a learning kit that may act as “Learning Milestones” for the children. The applications may interrupt viewing of films until certain tasks are completed. In an example, after every 10 minutes of a cartoon, the video may stop, and the child may need to complete 5 activities presented as per the mental age of the child such as matching a shape of an animal and its written name for learning vocabulary. The activities may be fun as well as educative. In an example, the child may need to subtract a number of characters of a cartoon video who had died during the video from the number of total characters of the cartoon video, thus the child remains focused and learns through the video.

The learning kit may not be selected by the child. However, the learning kit may interact with the existing content on a given trigger such as time-based trigger and the like. The existing content may act as a teaser to keep the child interested and focused. The learning kit may be configured through software development kit 124; other parties may enable their applications to act as learning milestones so that parents may decide what their children should learn.

A multi touch model may enable the child to draw on any displayable frame of a film, such as for putting a pirate hat on a character, and may thereafter print the same. The multi touch model may support the child interacting with the single frame of the film by placing two or more fingers directly on the surface of a screen displaying the frame. In an embodiment, an external drawing desk peripheral (that may be electronically attached to the system 100) may allow children to draw thereon and impact a frame of a film.

Publishers may add various Activity Packs to the videos. The Activity Packs may be a collection of fun activities specially designed for children. In an embodiment, when the Activity Packs may be acquired along with a film, such as through a media marketplace, simple games, songs, and “color in” sheets may be included in a Pack. When the children become engaged with the content, they can easily access the Activity Pack to continue playing. In an example, once the child becomes familiar with lower levels of the content, only then the child may be allowed to proceed to the games contained in the Activity Pack.

A simple interactive digital film creation or adaptation standard may be established that may help publishers to add various types of interactivity into a digital media file (e.g. a digital movie or film). In an example, a character may need to cross a river and the screen shows five items. The child may need to select the rope from the list before the video continues.

In an exemplary embodiment, an overlay over an existing display device such as visual screen, television, monitor, mobile phone, and the like may allow operation of the existing display device to operate the system 100. The overlay device may allow a tactile feedback to the child in response to initiation of a game. In an example, the overlay may bugle out to allow the child to identify the area associated with a particular button. Such an overlay may be configured to adapt a generic interface to allow the age-focused functionality described herein by guiding a user to a subset of the possible selections.

The overlay may include an overlay for a display, the overlay including an array of touchable elements that are configured to allow simplified interaction with a system associated with the display, wherein the system is otherwise designed for a general user. The array of touchable elements may be configured to allow simplified interaction based on a target age range of a user, such ranges may include ages: 0-1, 1-1.5, 1.5-2.5, 2.5-4, 4-6, and 6-8. The overlay includes tactile feedback and may be configured over a touch screen. When combined with a touch screen, the array of touchable elements may be configured for facilitating access to portions of a touch screen below the touchable elements, while reducing the likelihood of accessing portions of the touch screen that are not below any of the touchable elements.

The media library that may be accessible through the safe-media interaction software 114 may be customized with different aesthetics through “skins” that may be replaced by the user from a variety of available skins. The skins may be interchangeable; the user may also modify portions of the color and graphics of the skins. The skins may enable the user to change the sounds, animations, item placement and other functionalities of the media library. The skins may be acquired and installed through the online store 120 of the safe-media interaction system 100.

The safe-media interaction software 114 may provide a “Print It” functionality that may allow the user to capture any interaction on the safe-media interaction software 114 as a picture. In an example, the user may capture a frame of a black-and-white movie, add color to the picture within the movie frame, store the picture in a repository, and using the “Print It” feature may print the picture upon parental permission. The safe-media interaction software 114 may allow the user to maintain a video communication such as through video chats, and the like. By using a web camera, children may have remote video and audio interaction with friends and family Likewise, the video chat functionality may allow the child to receive incoming calls from friends. Further, images of friends may appear in the media library as media items such that the child may use the paradigm of ‘poking’ a friend to initiate or receive a video call. The video chat may be operated as a remote observation capability when it is activated in a silent mode that does not display the remote user (parent) so that parents may observe the child without disturbing the child. Further, the safe-media interaction system 100 may provide a content selection screen for the children.

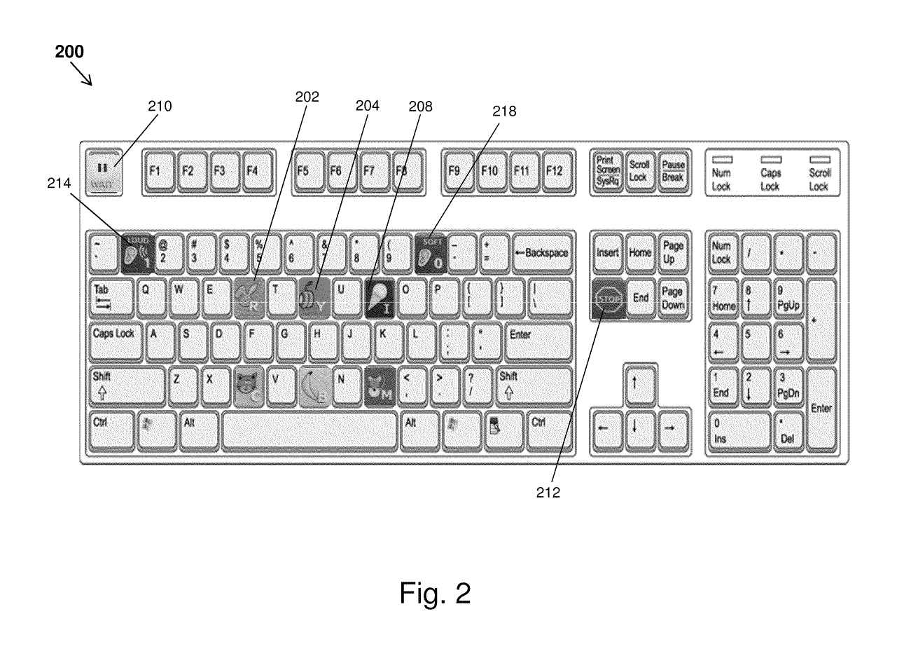

FIG. 2 depicts a customized user interface of the safe-media interaction system 100 that includes labels placed on keys of a typical computer keyboard 200. The labels may be adhesive; peel off stickers; and the like. Further, the labels may be identical to the icons presented in a child-specific user interface of the system 100. A user may select a digital image to represent computer renderable content. The digital image may be associated with the computer renderable content for presentation in a child-specific user interface. The association as mentioned above may include associating a keyboard key with the renderable content. Such an association may facilitate activation of the renderable content with the keyboard key. Further, the user may select a label of the digital image from a collection of age-specific labels and may dispose the selected label on the keyboard key. For example, the labels may include figures and letters such as R (rabbit) 202, Y (yoyo) 204, I (ice-cream) 208, and the like (as shown in FIG. 2). In an example, the safe-media interaction system 100 may include a game of counting ice-creams. The iconic image of such a game on the child-specific user interface may be an ‘I’ letter and a picture of ice-cream with it. The label 208 of the iconic image may be placed on the keyboard 200 at key ‘I’. Accordingly, whenever, the child may wish to play the counting game, he/she may press the ‘I’ key on the keyboard 200 to reach on that game. The labels may be of appropriate size that may allow convenient placing of the labels on the corresponding keys of the keyboard 200.

Further, a “WAIT” label 210 may be pasted on the escape key of the keyboard 200. The “WAIT” label 210 may be used to pause a video when pressed once. When the child again presses the “WAIT” label 210, the video may be resumed Likewise, a “STOP” label 212 may return the child to a main menu. From the main menu, “STOP” label 212 may prompt an exit window. In an example, to exit from a game, the child may seek assistance from parents. Parents may need to enter a password that may protect the child from visiting other websites on the Internet. In an embodiment, the labels may also come for adjusting the volume of the safe-media interaction system 100 as “LOUD” 214 and “SOFT” 218. The “LOUD” 214 and “SOFT” 218 labels may be pasted on 1 and 0 keys of the keyboard 200, respectively. It will be evident to a person skilled in the art that this association of the labels to keys is strictly exemplary and any positioning is supportable by the safe-media interaction system 100.

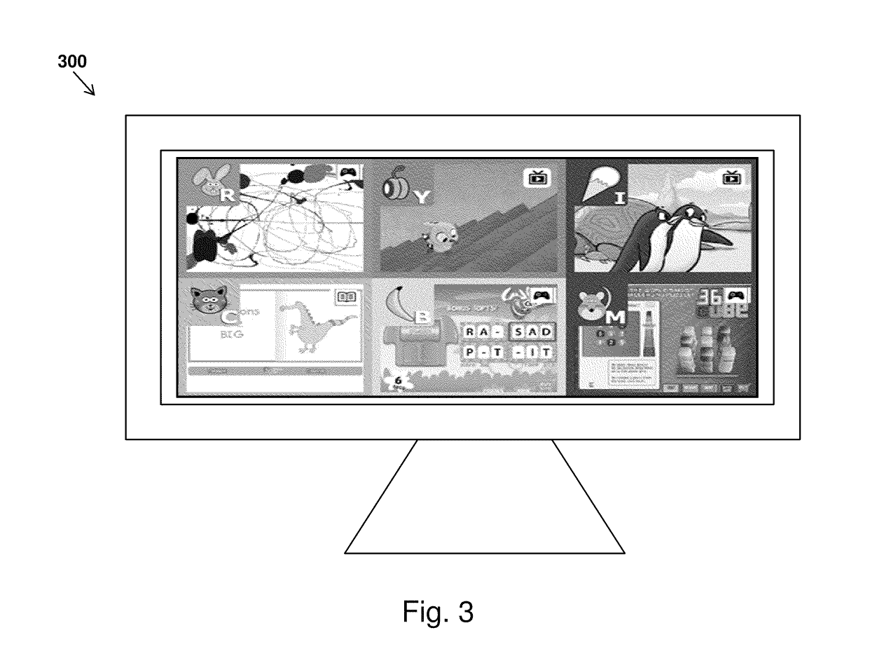

Referring now to FIG. 3, a content selection screen of a child-specific user interface 300 of the safe-media interaction system 100 is depicted. Such a child-specific user interface 300 may build an animated screen of media items and features accessible through a child's profile. The media items may include songs, images, videos, and the like. The features may include web chatting, live display of content, games, and the like. The items and features may correspond to the choices made by a parent of a child. Further, the items and feature choice elements may appear in an order that is selected by the parent, randomly generated by the safe-media interaction system 100, based on the child's prior interactions preferences, and the like. In the embodiment of FIG. 3, the selectable features and items may appear as a panel of six on a display device. The child may select one of the selectable features or items through a touchscreen, keyboard, mouse, audio input, or other means for the child to select one of the items or features. Each of the six panels may represent a type of content, feature, and the like. To select one of the six choices, the parents or child may press a key on a keyboard having the same color, icon, letter, and the like as the choice item. Alternatively, the child or parent may use a mouse as an input device to maneuver mouse pointer and click on one of the six thumbnails appeared on the display device. Yet alternatively, the display may be a touch screen and the child may touch one of the choice items or features to activate that item or feature.

In order to see choices other than first six, the child/parents may cause the choice items on the screen to scroll or rotate such as may be performed with a carousel type interface (e.g. by using a left or right arrow key). The screen may change to display at least one different choice item or feature. In the carousel embodiment, the screen may appear as a connected sequence of images that may move in a carousel type manner allowing a child to advance the carousel so that the image of choice is presented and selected by the child.

Further, the child-specific user interface 300 may include a visual indication of being connected to a network, such as the Internet. In an example a green circle may be displayed to indicate that the computer is connected to the Internet and a red circle may be displayed to indicate that there is no Internet connection. Such easy to learn visual indicators may enable a child to quickly determine if access to items stored remotely on the network is possible. Further, through a parent-specific user interface described below, parents may add text, images, and even HyperText Markup Language (HTML) content to impact the child-specific user interface 300. The content selection screen may provide interaction and dynamism to a user (children or parents) and may thus keep users engaged. The choice of items may be configured with child-friendly and age-appropriate images, text, and the like to facilitate easy identification and selection of the desired content by a child, even if the child cannot read. Once an item has been selected, the screen may display the individual item or provide access to a website, game, and the like.

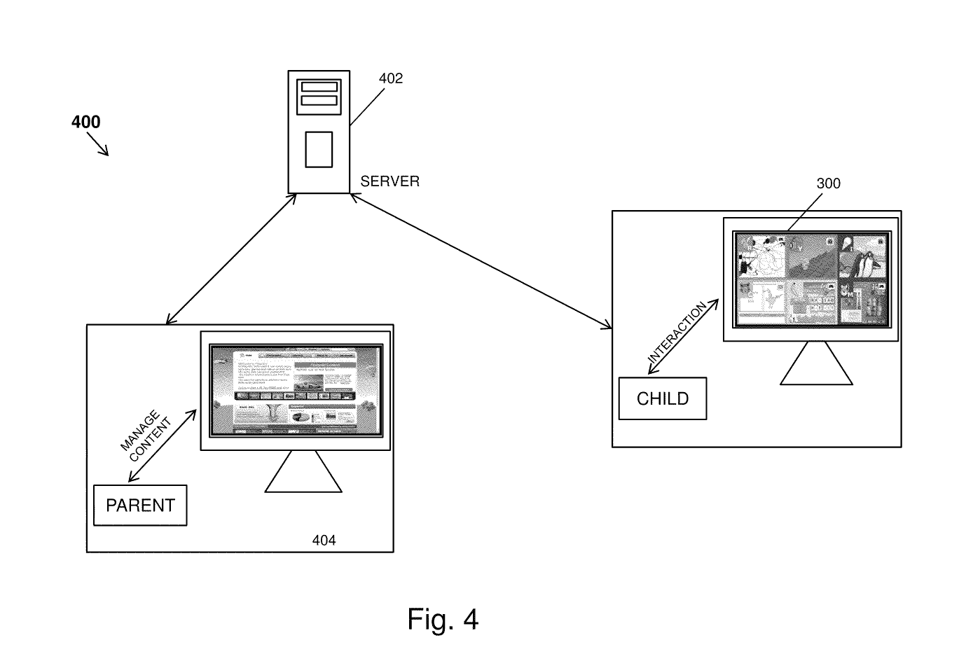

Referring now to FIG. 4, distinct parent and child interfaces of the safe-media interaction system 100 are depicted. Parents may manage contents of a child's profile by means of a server 402. In an embodiment, parents may access the safe-media interaction system 100 through an interface 404 (hereinafter referred as ‘parent-specific user interface 404’). The safe-media interaction system 100 may include the interface 118 that may provide a parent-specific user interface 404 and a child-specific user interface 300. Preferably, the parent-specific user interface 404 may be used by parents to organize control of and monitor their children's interaction with the safe-media interaction system 100. The parent-specific user interface 404 may also enable parents to grant permissions and access rights to other users or participants that may be accessible through the safe-media interaction system 100. In an example, parents may assign family members at far off places the permission to access the safe-media interaction system 100. Further, the interface 118 may include a web portal hosted in association with the safe-media interaction software 114. The web portal may be accessible via any conventional web browser. The interface 118 may be hosted in the age-oriented interaction device 102.

The parent-specific user interface 404 may include a plurality of functionalities such as a Login so that parents may have secure access to the safe-media interaction system 100. Parents may be prompted to enter a username and a password. In an embodiment, the username and the password may be provided to the parents at the time of registration with the safe-media interaction system 100. In another embodiment, when the parents are not be provided with a username and a password, a request may be sent to a technical support facility of the safe-media interaction system 100. Upon receiving the request, the technical support facility associated with the safe-media interaction system 100 may create a username and a password for the parents.

In an embodiment, parents may create profiles on the safe-media interaction system 100 through the parent-specific user interface 404 for saving their preferred items or functions. Once parents log into the safe-media interaction system 100, they may set profile for a child. The parent-specific user interface 404 may include a ‘Settings’ tab that may enable parents to create a profile for the child. For creating a profile, parents may need to add information about the child that may be requested by the safe-media interaction system 100. The requested information may include name of the child, gender of the child, date of birth of the child, a profile picture of the child, and the like. To upload a profile picture of the child, parents may navigate through various files that may be saved by them on a computer. In case parents may not want to upload an image of the child, the safe-media interaction system 100 may select an avatar for the child.

Further, parents may create profiles of more than one child from a single parent account. In an embodiment, when parents have more than one child, they may add information about all the children. However, in a single account, parents may add only three children at a time. In another embodiment, when parents may want to add more children, they may need to create another account on the safe-media interaction system 100. Further, the user may add content on the child's profile. If more than one child shares the same system, parents may need to configure the child-specific user interface 300 in different ways for every child, thereby making instances of the child-specific user interface 300 that are child-defined. The parent-specific user interface 404 may allow parents to manage a media library created thereon by the parents. Specifically, the parent-specific user interface 404 may allow management of all the content that may be accessible by the child. The safe-media interaction system 100 may automatically classify the content in various categories. The safe-media interaction system 100 may also automatically identify favorite media items based on a measurement of usage of by the child. Parents can always decide to override these features with their own choices.

Further, parents may quickly add information on the child's profile. The safe-media interaction system 100 may provide a ‘Fast-Fill’ option to the parents for adding playground and recommended content in the child's profile in a quick and easy manner. The safe-media interaction system 100 may add playgrounds and other content based on the age of the child, gender of the child, and the like. In an example, the ‘Fast-Fill’ option may select 18 pieces of content that may include five playground pages and other recommended content. Parents may select the child for whom they may like to use this option and may click on a ‘fill up’ button. The ‘Fast-Fill’ option may also add some media that may be selected by the safe-media interaction system 100 in the child's profile.

Alternatively, parents may manually select the content that they may want to add to a child's profile. The online store 120 provided by the safe-media interaction system 100 may enable parents to use filters or search through the content available on the safe-media interaction system 100. Accordingly, parents may select the content of their choice to be added into the child's profile. Once parents have selected the content to be added, they may add the selected content to the playgrounds of children. In an example, when parents have added more than one child in their account, they may be presented with an option to select the child in whose playground they may wish to add the content.

In an embodiment, parents may provide access to selected contents of the online store 120 to the children. The selected content may include free on-line content, buying movies, games, and the like. Further, the online store 120 may be used by parents, content providers, administrators, and the like. Users of the online store 120 may need to login to access their profiles. In an embodiment, parents may need to login to access the online store 120. Further, parents may acquire free as well as paid media from the content providers. Parents may also search through the content available in the online store 120. The search may be performed using various criteria such as search based on categories of the content, newest content, most viewed content, highest rated content, keyword, and the like. Further, parents may review existing subscriptions of the content being used by the children and may also subscribe to new media from content providers.

Further, after adding the content to the playground of a child, parents may organize the content. In an embodiment, the safe-media interaction system 100 may allow parents to view all the items that may be selected by parents for an individual child. Parents may edit the items such as re-arrange the content; delete some of the items, and the like. In another embodiment, the system 100 may allow parents to collectively view all the items that may be in a child's playground.

The parent-specific user interface 404 may include a scheduling system for enabling parents to schedule the interaction between the safe-media interaction system 100 and the children. In an example, parents may use this scheduling system, which may look like a simple calendar interface, to put constraints on the amount of time and dates for usage of the safe-media interaction system 100 by the children. The safe-media interaction system 100 may, by default, be used from 8 AM to 12 PM, and 4 PM to 8 PM for a maximum of 2 hours a day.

Alternatively, parents may limit the usage of the safe-media interaction system 100 by using a rewards system. The rewards system may inculcate good habits in their children. The rewards system may require the use of a certain number of “coins” per unit of time. The currency may be added on a weekly basis, or upon completion of certain tasks at the parents' discretion. In an example, children may earn the currency based on various activities such as cleaning up the dishes, having great scores in the last school paper, and the like.

In an embodiment, the media content may be accessed in an online media store 120 and then may be watched by the child. The safe-media interaction system 100 may also include access to an online store 120 that may be web-based. The online store 120 may be accessible through the parent-specific user interface 404 to subscribe to new content and acquire applications such as tunes, games, and the like for their children. The online store 120 may include access through a web portal hosted in the Internet 110 such as through a wide variety of on-line retailers for purchasing online games, media files, media libraries, peripherals and the like. Further, parents may also acquire a private repository to store their own user-generated content and share it with selected parties such as other family members. The online store 120 may be controlled according to a set of standards (e.g. by a company that enforces the standards) so as to ensure that only certified content that abides by the standards may be published. The online store 120 thereby preserves a safe merchandising environment for families.

The online store 120 may be used by parents, content providers, administrators, and the like. Users of the online store 120 may need to login to access their profiles. In an embodiment, parents may need to login to access the online store 120. Further, parents may acquire free as well as paid media from the content providers. Parents may also search through the content available in the online store 120. The search may be performed using various criteria such as search based on categories of the content, newest content, most viewed content, highest rated content, keyword, and the like. Further, parents may review existing subscriptions of the content being used by the children. They may also subscribe to new media from content providers.

The parent-specific user interface 404 may allow access to online store 120 for subscribing contents, and the like, from seamlessly integrated data. Parents may review existing subscriptions and may acquire new content for their children. The costs associated with the content will vary depending on the business model of the publisher. In an example, television ad-sponsored channels, series teasers, and the like may be free content. Moreover, the content may be subscribed by paying a one-time fee. Further, the subscription may be based on automatic updates for certain recurring revenues, and the like.

In an embodiment, the collective view may enable parents to rate any media item by clicking on the media items. Parents may rate the content stored in the online store 120 as per the usefulness thereof. For example, parents may rate the media items of the online store 120 for fun and educational value. The ratings provided by parents of various children may be aggregated and then may be shared with all users of the safe-media interaction system 100. Further, parents may provide their comments on the contents used or reviewed by them. The online store 120 may provide payment methods, which may be stored for repeated usage. In an example, on subscribing to a particular content from the online store 120, a parent may select from various payment options available thereon to pay.

The online store 120 may be accessed by content providers. The content providers may need to log in to their profile. The content providers may publish new content that may be available in the online store 120 after a certification process. The new content may be reviewed by the service providers who are responsible for the child-safe benefits of the invention before being published. The content provider may manage all the content that may be published in the online store 120. Further, the online store 120 may facilitate the content providers to rearrange different items by ramping up and down different items based on the product lifecycle. The content providers may obtain detailed statistics about content acquisition by different users, revenues generated and usage patterns. The content providers may sign contracts with service providers for seasonal promotion campaigns.

The online store 120 may be accessed by administrators. The administrators may need to log in to access their profiles. The administrators may be able to manage parent and content provider accounts. Further, the administrators may be able to manage the online store 120. The safe-media interaction system 100 may obtain detailed statistics about all content acquisition, revenue and usage patterns. Further, the administrators may be capable of publishing updates on the safe-media interaction system 100.

The safe-media interaction system 100 may include a software development kit 124 that may be used by third party developers for creating software customizations of hardware accessories that may interact with the age-oriented interaction device 102. The software development kit 124 may also be used for creating applications that may be acquired and installed from the online store 120 to run in the safe-media interaction software 114 such as interactive videos, games, educational software, and the like. Further, the safe-media interaction system 100 may track the activities of children.

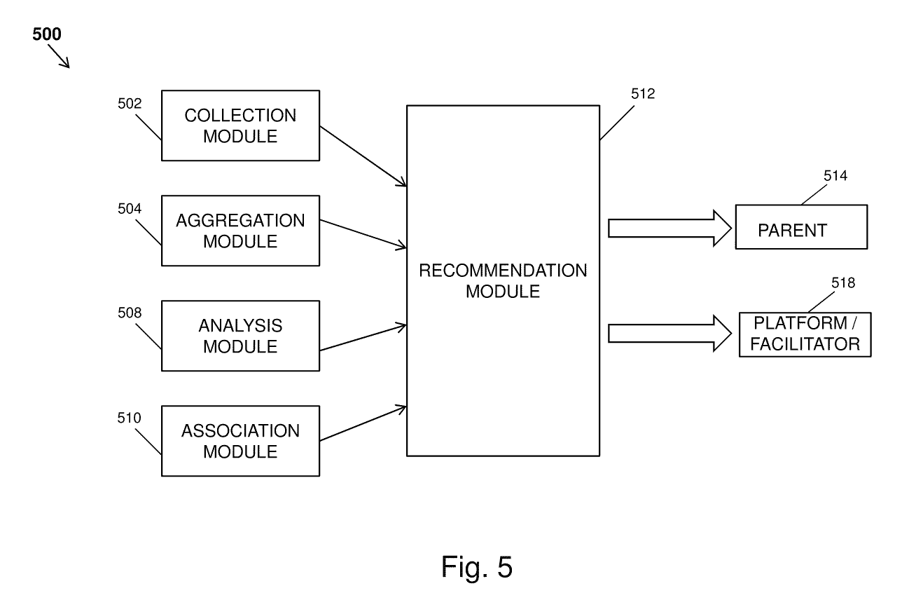

FIG. 5 depicts a recommendation engine 500 and method that is associated with the safe-media interaction system 100. The recommendation engine 500 may enable the safe-media interaction system 100 to record all interactions of a child with the system 100 so as to provide statistics about the usage patterns of the safe-media interaction system 100. The statistics may also include reports, charts, and the like, for the usage patterns. The recorded interactions may be aggregated across many children to generate recommendations of content, features, and the like, that may help parents 514, content curators, third parties, and the like to better manage the system 100, content for a child, and the like. The recommendation engine 500 may include a collection module 502. The collection module 502 may collect data on interaction patterns of a plurality of child users with a plurality of child-specific user interfaces. Further, collection module 502 may take a collection of frequent item sets as input and may generate a recommendation set for a child by matching the child's current activity against the discovered patterns. Further, the recommendation engine 500 may include an aggregation module 504 that may aggregate the interactions across the plurality of child users and over time. The recommendation engine 500 may also include an analysis module 508 that may analyze the aggregated interactions of the plurality of child users over time to detect patterns and tendencies in the interactions.

In addition, the recommendation engine 500 may include an association module 510. The association module 510 may associate the detected patterns and tendencies with a demographic aspect of at least one child of the plurality of child users. Further, the recommendation engine 500 may include a recommendation module 512 that may recommend at least one of a content item and a feature for including in a child-specific user interface of the at least one child. The recommendations may be provided for content, features, future activities, and the like, for a child. For example, based on the reading habits of the child, the recommendation module 512 may recommend additional reading options. The parent may accept or select one or more of these recommendations thereby making the new reading options available to the child in the child-specific user interface 300. Likewise, the recommendation module 512 may recommend various videos and music based on the observed interaction patterns of the child. The recommendations of the recommendation module 512 may be accessed by parents 514 through a parent-specific user interface 404. The recommendations may also be accessed by a platform/facilitator 518.

Further, the safe-media interaction system 100 may allow parents or other authorized individuals to review the recorded interactions in the parent-specific user interface 404. The safe-media interaction system 100 may facilitate generation of reports based on the past activities of the children. The reports may include the list of media content such as movies, games, online applications, and the like viewed by the child. Further, the reports may include the start time, end time, and the total duration of the visited media items. Based on this information, the safe-media interaction system 100 may prepare charts such as a pie chart that may show the most frequently accessed media items.

The parent-specific user interface 404 may allow parents to review the logged interactions of the child with the safe-media interaction system 100. The statistics functionality described herein may be used by parents to decide on the future usage of the safe-media interaction system 100. Parents may subscribe to a parental advisory service that may leverage various usage patterns to assess the development of the child. The parental service advisory may access the logged interactions, the statistics, and the like to provide recommendations for future activities, new content, and the like.

The interface 118 may also include a notification function. The notification function may include messages that may range from upgrade alerts, parental advisory service recommendations, advertisement such as new products released in the online store, and the like. Further, a copy of the messages may also be delivered to a mail address provided by the parents when they may opt for the notification functionality. The interface 118 may allow parents to select friends from family members and other contacts.

In an embodiment, the child may interact with trusted family members through video conferencing. The interface 118 of the safe-media interaction system 100 may allow parents to add or remove permissions from friends to interact with the children using the video chat functionality. Further, the interface 118 may include functions that access a digital data repository that may enable parents to store all the creations of the child such as short videos, screen captures, sketches, and the like. Parents may review the creations of the child and may optionally share or print them. In another embodiment, the content associated with the safe-media interaction system 100 may be shared between the child and friends.

Parents of the children may acquire a family album such as a private repository for storing their own user-generated content such as details of the subscribed content, users having access thereto, and the like. Further, the family album may be shared with selected parties such as other family members, friends, and the like.

Parents may be able to publish new content in the family album. The new content published in the family album may automatically get reformatted as per the format of the previously published content. The content shared by other contacts may be imported into the family album Likewise, the safe-media interaction system 100 may enable the child to augment the content with information such as tags, categories, ratings and comments, and the like. Further, the content saved in the family album may be made accessible to the safe-media interaction system 100.

The safe-media interaction system 100 may facilitate securely enhanced flow of media and content through devices such as television, the Internet, mobile phone, and the like. The enhanced information may be controlled by a third party, other than the user of the safe-media interaction system 100. The user may be a child and the third party may be a parent of the child. Therefore, the parent may ensure safe and useful information provision to the child.

Various embodiments of the invention may enable a third party to remotely operate the media rendering devices to render the media or content selected by them, and received by the user. In an example, a parent may select an educational video of interest to the child. The selection may be made through a web-enabled interface. The selected educational video may then be made available to a remote output device operable through safe-media interaction system 100, by the child. In this example, the safe-media interaction system 100 may receive the selection made by the parent and display the selection to the child while the child is viewing an output device such as a television or a computer. The child may then select to view the video chosen by the parent.

The safe-media interaction system 100 may display multiple options for availability to the user, by one or more trusted third parties. The user may select one or more of the available options through safe-media interaction system 100 to receive them. Examples of options may include play books, songs, other customized media items, and the like.

The safe-media interaction system 100 may enable interactive communication between the user and rendered media or the third party. In an example, the user may select an option to purchase an item received on the output device. The selection may alert the third party to conduct the transaction for purchasing. The selection may auto-complete the transaction such that the purchase is made by the user. In various embodiments, the interactive communication may be extended to interactive educational media, instant messaging, video conferencing, and the like.

The software development kit 124 of the safe-media interaction system 100 may allow third party publishers to add interactivity to their existing media without having to re-create it from the ground up as an application for either educational (e.g. the Learn Spanish video now pauses and invites the child to repeat the sentence with some degree of accuracy) or recreational purposes (e.g. a video pauses while the child completes the action that the characters in the video required).

The safe-media interaction system 100 may include age-oriented interaction device accessories 122. The age-oriented interaction device 102 may be a platform that may allow development of add-ons to extend base functionality. Aside of the different types of Remote Controls, other examples may include touch screens, digital cameras, drawing pads, media rich toys, and the like. Functioning of the safe-media interaction system 100 may be enhanced by integrating the safe-media interaction system 100 with peripheral devices such as a digital camera. Children may take the digital camera for shooting their own videos and pictures using themes and techniques they may have observed with the system 100, and the like. The videos and the pictures may then be seamlessly downloaded and integrated into the safe-media interaction system 100 and shared with other people at a later date and time.

A monitor may be combined with the age-oriented interaction device 102. The monitor may be a special purpose screen that may be used at home. The monitor may allow usage at various places such as in a car, while resting on the backside of the passenger's seat, and the like. A microphone may be used as an accessory along with the age-oriented interaction device 102. The microphone may allow the user to sing along during the videos and record their voice. The accessory may be a car charger that may be attached to the age-oriented interaction device 102 and connected to an electric outlet of the car for usage on the move.

The age-oriented interaction device 102 may be combined with a timer. The timer may be used as a shutdown mechanism such that at night a user may leave a song playing while the child is trying to go to sleep. The age-oriented interaction device 102 may thereafter shut down in the specified time. In an embodiment, batteries may be connected to the age-oriented interaction device 102 for being conveniently taken out of the home. The batteries may be plugged to the age-oriented interaction device 102.

The age-oriented interaction device accessories 122 may also include a web camera. The web camera may allow video chat functionality with family and friends. Further, the web camera may integrate with other applications to provide interactivity such as input gestures, and the like. The accessories may include a sketchpad. The sketchpad may allow children to draw on the surface of the sketchpad.

The safe-media interaction system 100 may include a second accessory 122 for the age-oriented interaction device 102. The hardware kit 128 may be used by third party developers for creating hardware accessories that may interact with the age-oriented interaction device 102. The age-oriented interaction device 102 may include a built-in touch screen and a camera, in some editions of the safe-media interaction system 100. Further, the safe-media interaction system 100 may support languages other than English, Spanish and Chinese.

The safe-media interaction system 100 may enable selection of whole or specific portions of the media. The selection of whole or part of the media may be performed by choosing one or buttons or other forms of selection interfaces associated with it.

The safe-media interaction system 100 may include a third party control facility for filtering content available to the user when they access content from a plurality of sources. The content filtering may be based on pre-defined rules or may utilize an algorithm. In addition, the filtering may be customized by the third party through a user interface. The interface 118 may appear on the screen of a digital device such as cell-phone, mobile phone, PDA and the like, accessible through an IP address or available on web. The interface 118 may allow the third party to select categories accessible to the user. Alternatively, the interface 118 may allow selection of media or content that may be restricted for being received by the user. In an embodiment of the present invention, the safe-media interaction system 100 may be used as a Dance Dance Revolution (DDR) game.

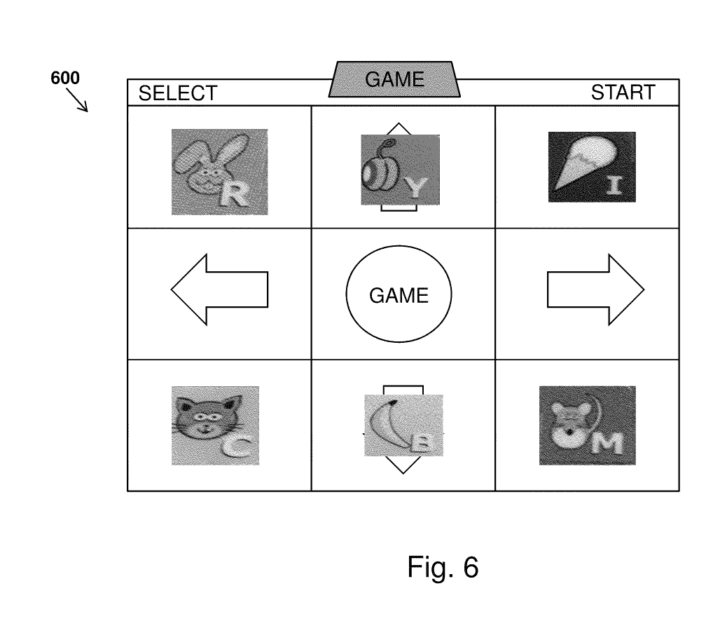

Referring to FIG. 6, a dance pad input device associated with the safe-media interaction system is illustrated. The dance pad 600 may include various symbols such as arrows, letters (R, Y, I, C, B, and M), images, icons, start and stop indicators, and the like configured thereon. The dance pad 600 may include different colors for each symbol. Further, the dance pad 600 may be plugged into any USB port of a computer on which the safe-media interaction system 100 is executing. The start indicator may enable a child to start an application or menu for games. The child may browse through the contents of the safe-media interaction system 100 and may select a desired content by using the letters printed on the dance pad 600. In addition, the right and left arrows may be used to switch pages. In use, while playing a game, the child may move his/her feet to a set pattern and stepping in time to the general rhythm or beat of a song.

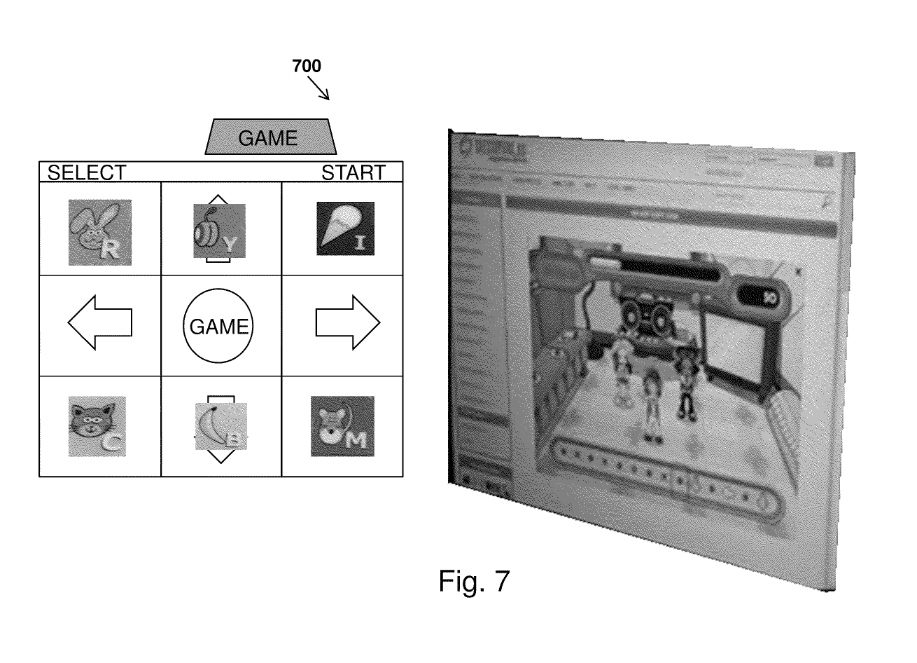

Referring to FIG. 7, a game or other feature of the safe-media interaction system 100 that facilitates interaction with the dance pad 600 is depicted. A child may stand on the dance pad 600 that is connected to the computer and may step on the symbols based on musical and visual cues that may be provided through the child-specific user interface 300. For example, a video may appear in the interface 300 with the arrows to be stepped on may be highlighted. The child may be judged by how well he/she time their dance to the patterns presented to them. If the child receives a passing score, the child may be allowed to choose more music to play. Based on correct judgment of the arrows, the child may step on the highlighted items and may thus move to higher and difficult levels of a game. Alternatively, the dance pad 600 may be used in lieu of a keyboard or touchscreen to enable a child to access any or all of the features and/or content of the safe-media interaction system 100. These and many other applications are possible when the dance pad 600 input device may be combined with the safe-media interaction system 100.

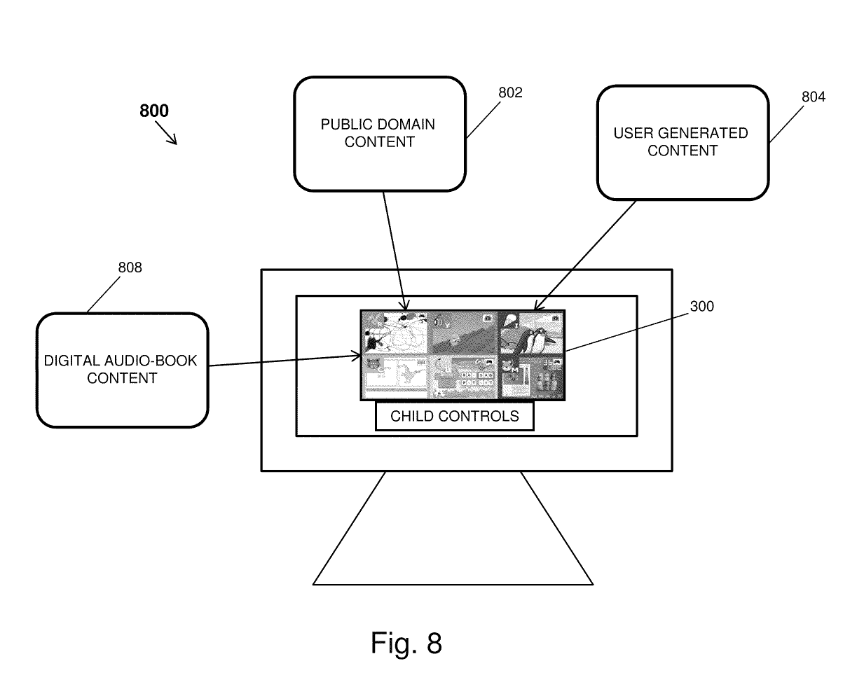

FIG. 8 depicts accessing multiple types of content through the child-specific user interface 300 of the safe-media interaction system 100. In an embodiment of the present invention, the safe-media interaction system 100 may provide access to selected public domain content (on-line content) 802, user-generated content 804, digital audio-book-type content 808, and the like. The public domain content 802 may include information that may be freely available to a user. Further, the public domain content 802 may be derived from public networks such as Internet, and the like. The user-generated content 804 may include content that may be created by a user such as home generated videos, images captured during a vacation, and the like. Such content may be stored at a local machine such as at a computer, laptop, and the like. The user generated content 804 may also include content that may be shared between private networks such as a Local Area Network (LAN). The private network shared content may be used for homes, offices, and the like. In an embodiment, the user-generated 804 content may also include content present in the public network and that may be freely available.

Further, the digital audio-book content 808 may include digital content that may be freely available such as through public networks (e.g., Internet). The users may search through an iTunes™ interface that may link to iTunes™ website for receiving digital content. Further, the users may browse through a local iTunes™ library for retrieving digital audio-book content. Parents may configure and arrange controls presented in the child-specific user interface 300 to allow access to a subset of the various types of content accessible through the system 100.

In an embodiment, identifiers of content in the child-specific user interface 300 may be taken. The content may be the public domain content 802, the user-generated content 804, and the digital audio-book content 808. The identifiers may include information that may facilitate a computer to access the content. Further, a user interface for the child-specific user interface 300 may be configured to blend the user-generated content 804 with at least one of the public domain content 802 and the digital audio-book content 808. The blending may be done by associating the identifiers of the user-generated content 804 and the identifiers of the at least one of public domain content 802 and the digital audio-book content 808 with the child-specific user interface 300. In an embodiment, the child-specific user interface 300 may be configured through a parent-specific user interface 404.

The safe-media interaction system 100 may be capable of playing audio content such as books on tape, purchased or downloaded movies, movies on demand accessed over the Internet, and the like. The system 100 may also support accessing selected on-line videos such as from video websites and from the media library. In another embodiment, the system 100 may enable parents to upload movies such as home videos, movies created at home, Digital Video Disc (DVDs), and the like. Video chat sessions can be captured and saved for access by the child. Also, a parent or grandparent may use a computer's video camera capability to prepare a video (with audio) of the parent or grandparent and make it accessible to the child.

The child-specific user interface 300 may be adapted to support display of controls and content from any of the sources and types of content that are accessible through the platform by allowing parents to blend user-generated content with other content (e.g. media files). This blending may provide, in a single child-specific user interface 300 multiple types of content. For example, parents of a child may record a video using a digital camera during vacations with friends or relatives. Parents may upload that video to the system 100 so that the child may access the video whenever the child may wish to. Further, parents may also add an audio file (a song) to the video.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. The process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. An overlay for a display, the overlay including an array of touchable elements that are configured to allow simplified interaction with a system associated with the display, wherein the system is otherwise designed for a general user.

2. The overlay of claim 1, wherein the array of touchable elements are configured to allow simplified interaction based on a target age range of a user.

3. The overlay of claim 2, wherein the target age range is one of 0-1, 1-1.5, 1.5-2.5, 2.5-4, 4-6, and 6-8.

4. The overlay of claim 1, wherein the overlay includes tactile feedback.

5. The overlay of claim 1, wherein the overlay is configured over a touch screen.

6. The overlay of claim 5, where the array of touchable elements is configured for facilitating access to portions of a touch screen below the touchable elements, while reducing the likelihood of accessing portions of the touch screen that are not below any of the touchable elements.

7. A method, comprising:
selecting a digital image to represent computer renderable content;
associating the digital image with the computer renderable content for presentation in a child-specific user interface;
associating a keyboard key with the renderable content, to facilitate activating the renderable content with the keyboard key;
selecting a label of the digital image from a collection of age-specific labels; and
disposing the selected label on the keyboard key.

8. The method of claim 7, wherein the renderable content is at least one of a picture, video, games, movies, and online applications.

9. The method of claim 7, wherein the child-specific user interface comprises visual indicators to facilitate a user to determine the Internet connectivity.

10. The method of claim 7, wherein the labels comprises at least one of: a figure, letter of alphabet, and words.

11. The method of claim 7, wherein the labels are self-stick adhesive labels.

12. The method of claim 7, wherein the labels are peel-off labels.

13-18. (canceled)

19. A method of recommending content and features for a safe-media interaction system, the method comprising:
collecting, with a recommendation engine, interactions of a plurality of child users with a plurality of child-specific user interfaces;
aggregating the interactions across the plurality of child users and over time;
analyzing the aggregated interactions to detect patterns and tendencies;
associating the detected patterns and tendencies with a demographic aspect of at least one child of the plurality child users; and
recommending at least one of a content item and a feature for including in a child-specific user interface of the at least one child.

20. The method of claim 19, wherein recommending comprises recommending at least one of future activities and new media items.

21. The method of claim 19, wherein the recommendation engine generates at least one of reports and charts based on the interactions of users with the safe-media interaction system.

22-30. (canceled)
